(19) United States
(12) Patent Application Publication
(10) Pub. No.: US 2014/0120195 A1
(43) Pub. Date: May 1, 2014

(54) Three Dimensional Contour Shaping Apparatus

(71) Applicant: Yamandu Zavish Ploskonka, Austin, TX (US)

(72) Inventor: Yamandu Zavish Ploskonka, Austin, TX (US)

(21) Appl. No.: 14/038,746

(22) Filed: Sep. 26, 2013

Related U.S. Application Data
(60) Provisional application No. 61/705,629, filed on Sep. 26, 2012.

(51) Int. Cl. B29C 33/42

(52) U.S. Cl. CPC B29C 33/42
USPC 425/174; 425/451.9

(57) ABSTRACT

A shaping or forming apparatus, comprising a plurality of members, means to selectively lock the rows in a set position with a force greater than that used to position unlocked members, and means to selectively position members relative to each other in more than three different positions.

A non definitive list of practical applications comprise at least one of: form, deform, shape, cast, mold, haptic output, visual output, control of material flow, control of force.

### CROSS REFERENCE

This application claims the benefit of U.S. Provisional Patent Application No. 61/705,629, filed Sep. 26, 2012, which is incorporated herein by reference.

### FIELD OF THE INVENTION

Technology to produce three dimensional contours for a variety of uses, comprising but not limited to apparatus, methods and products that display such contour and/or objects that comprise such contour.

### BACKGROUND OF THE INVENTION

Three-dimensional surfaces and objects are one of the oldest arts, marking the start of what we know as human culture and civilization. While rough shaping is something any person can do, precise shaping by hand is a non ordinary task, reserved to highly trained and experienced sculptors. Such work comprises adding material together to form a shape, as in ceramics, welding, glass work, or a malleable, flexible or plastic material is shaped anew or involves carving away from a solid block of material, most usually stone or wood, though also metals and others.

Industry has devised means to produce many copies of objects quickly, using less skilled labor, through casting, molding or other shaping means. A mold is shape directly and/or made using a pattern, allowing for quite fast industrial copying of the exact same shape, or with very limited variations, which becomes quite affordable when a given design is reproduced many thousands of times, giving a handsome return on investment in the original, the mold, machinery, materials and labor.

However, making changes in a mold or pattern is costly, as it often involves making a new one.

Much of modern day machining is carried out by computer numerical control (CNC). Digital computers are widely used to control the movement and operation of mills, lathes, and variety of other cutting machines to reliably produce three-dimensional objects, reducing costs in some circumstances.

With the aim to lower costs in one-off objects, and/or short runs, additive technologies have been the object of many recent advances, and are developing new industries under the names of rapid prototyping, rapid fabrication, additive manufacturing, 3D printing. A number are almost viable within an office or desktop environment, in size, speed and affordability. One of the main directions of rapid fabrication development relies in precise depositing a jet or string of a fluid or plastic material that will quickly aggregate to the bed or previous layers, and harden, be it by thermal, photo reactive or chemical means, and/or will act as a bonding means when deposited locally unto another substance, the latter presented usually as layers of powder or particulates; In many ways this is seen as closely related to the art of inkjet printing.

Very high temperature, focused, precise sintering of certain metal particles is also being done, likewise, layer by layer. Such controlled sintering of meltable particles layers is nowadays a common practice, using sugar, plastics, and other materials, even a number of metals, the later at a quite high cost compared to industrial production of metal parts, and limited to very few choices of metal and alloys. Also in methods where a laser is used to selectively harden areas within a vat full of expensive photo reactive resin, the non-hardened material needs be removed later, sometimes discarded for getting contaminated.

Of minor import yet in its industrial impact is the controlled cutting of material out of flat sheets, superposing the cut pieces, and thus forming a solid, three-dimensional object. Also, but not yet beyond the level of research, is the pursuit of atom- or molecule-level deposition, this being a nano-size version of the basic deposition process.

Because of the constraints existing when it comes to selecting a material that will both be easy to handle prior to deposition, and, will not lose shape, and will selectivelly fully aggregate and still harden quickly once it is extruded or hardened, the choice of materials that can be printed additively with success is quite limited, and more often than not they are rather expensive compared to materials used in other shaping and casting arts.

For example, metals, glass and ceramics are mostly out from direct three-dimensional additive printing deposition processes. While a number of industries advertise this capability, their products are crafted by rapid fabrication of either a lost core casting pattern, including vents, funnels and other such element as required by the art, that then takes the role of a core within the traditional metal molding process, and/or an actual mold, where a casting is later made to obtain the final object, in another, preferred material. It is thus possible to achieve, in limited form, “additive printed” parts outside of the extremely limited scope of those metals that can be sintered. This is particularly important when taking into account that the layer deposition process introduces weaknesses that a more traditionally cast part or piece would not have.

Current state-of-the-art, layer-based additive printing has still many limitations. Primarily, it is a slow process. Compared to typical turnaround times of less than a minute for an injection-molded piece, or printing one page by inkjet or laser technologies in a few seconds, the several hours or even more than a day necessary to aggregate a given three-dimensional object produced by additive printing is only acceptable because, even so, often it still is faster, less expensive and more precise than an expert to precisely machine or sculpt a given object.

Very fast shaping, transformation and formation of large objects is currently only in fiction and virtual worlds, or extremely limited, as in pre-shaped elements. Computer-based, virtual three-dimensional representation relies on the use of virtual wireframe models as an established and accepted mathematical model approach. Such a wireframe model represents the shape of what were a solid object using lines and points that describe an approximation to its contour. Hayes et al. U.S. Pat. No. 4,646,251 (1987) recite a number of basic principles used to display three-dimensional reality using two dimensional media and displays, which is the current most widely understood and developed state-of-the-art in the field of fictional, virtual three-dimensional representation, particularly for computer and entertainment displays and movie production.

There has been limited success in forming actual physical three-dimensional shapes that would reflect such virtual-reality creations, and/or to manipulate transformable shapes for other purposes, as were for example the control of fluids, and/or aerodynamics or hydrodynamics, and/or force fields, even though much effort and expense has been invested in such. Animatronics is a very limited and specialized field so far, and attempts in other arts have been limited by high cost, and/or heavy weights of the necessary parts, and/or the lack of a suitable, user-friendly integrated approach for shaping a material three-dimensional contour or its approximation. Limited success has been achieved for certain three-dimensional, static objects, out of a matrix of parts. For example, shaped contour rugs are commonplace, as are patterned textiles, even several ancient cultures used objects such as varidimensional bricks or blocks of stone to build three-dimensional sculptures.

The closest is the controlled jets of water that are common in certain landscaping and entertainment parks. However, their scope is much more limited than what is described in this disclosure. Holographics could be also compared to an embodiment in its purported results, were it not for its enormous cost in resources and technology, especially to compute its necessary calculations—and are not actual, material three-dimensional objects.

Fleming U.S. Pat. No. 4,536,980 (1985) pin screen and further disclosures such as Application US2004/0,020,087 teach one plate or several plates with a plurality of closely spaced small apertures corresponding in placement and alignment between plates if more than one plate, each one receiving a movable pin, its long dimension being perpendicular to said plate. When urging an object against these pins, these are selectively displaced proportional to the contours of the object, the plurality of pins recreating the shape of the object. in '980 this shape cannot be preserved. '087 claims an additional plate that slides sideways as means to lock all the pins simultaneously. '087 also claims the apertures be spaced apart, in parallel relation to each other. Drawings for '980 teach similar placement. There is no teaching for non-parallel members.

Vollom U.S. Pat. No. 6,298,587 B1 (2001) claims means for a semi-permanent impression in a print screen either by magnets permanently affixed to a holding structure when using pins made of a magnetic material, or with a ladder-like assembly that would frictionally engage the shanks of all the plastic pins simultaneously.

The core of the celebrated Gutenberg invention is the use of movable type. Standardized, generally of uniform length and height rectangular prisms, each one having the contour of one end shaped as a character to be printed and different width according to a given character. Type is generally set as a line, to reproduce and represent a line of writing. Those lines of type are laid in a chase frame to print a whole page, conforming a sort of matrix. When several such frames are set together in a printer bed it is possible to print multiple pages in one single pass. It is radically important that, as a frame is moved or even lifted, type does not move: a pied page is disastrous in a typesetting operation. Type is firmly tightened in line to keep its position by quoins, which can be removed or released as necessary to edit or position type in an out of a given line. Independent quoins for each line allow to selectively release a single line, while keeping the others firmly in position. By the nature of the art, a chase of type is meant to be kept generally flat, the main length of each type to be perpendicular to a reference plane defined by the chase.

While allowing for movable members of different size, a valuable and productive contour of a chase of type is achieved as the sum of the contours of a portion of each member, the face of each type.

While the purpose of the pin screen is direct aesthetic appeal and entertainment, the purpose of a chase of type is an industrial process, printing. Thus and because of its impact in valuable economic production, even such a seemingly minor element as quoins was developed and improved upon continuously, beyond the early wood wedges forced with a mallet, up to small gadgets that could expand and lock with the use of a quoin key, such as recited in Htjise U.S. Pat. No. 1,536,344 (1925).

Handte U.S. Pat. No. 4,265,024 A (1981) teaches a jig including a plurality of bars parallel to each other mounted on a frame for independent sliding movement, and a set screw for releasably holding the bars in desired positions, teaching a threaded screw quoin perpendicular to the members length, and lockable, reseteable members, albeit in Handte this were a single row. Cooper U.S. Pat. No. 4,265,024 (1952) teaches two apertured tubes, where the axial displacement of one relative to the other locks one row of otherwise slidable fingers in place

Curchod U.S. Pat. No. 4,454,618 (1984) teaches an elongated inflatable expansive tubing and wedges between adjacent pairs of columns of pins, to urge laterally such pins to simultaneously lock them into position.

Braille output using pins is the object of several inventions. To conform to the Braille specifications, the recited displacement of the members by the actuators in an apertured plate embodiment is binary, that is, displaced fully up, at rest when fully down, and the placement of the apertures is in sets of three rows of two apertures, conforming a rectangle. As to a matrix of pins displaced within a multiple range of positions, Skinner 2009/0130639 recites specifically and limited to representing the brightness of a graphic image, strictly using computer-driven actuators, this teaching away from uses that would not be related to the tactile display of graphic members of flat images.

Adamson et al U.S. Pat. No. 5,159,362 A (1992) present a predefined solid object pressing against a flat elastic membrane, thus deforming it into a contoured three-dimensional object with limited variation as to shape. Page U.S. Pat. No. 7,019,898 B2 (2006) likewise teaches a reconfigurable contour comprising an elastic sheet also held into deformed position by vacuum after being actuated on, yet in Page the defining agent can have any variable shape, by the use of a matrix of vertical parallel members. These are fitted with two series of pneumatically controlled locking mechanisms, one for the X-coordinate and one for the Y-coordinate. This locking mechanism differs from Curchod where all pins are urged laterally to lock simultaneously, while in Page the locking operation can selectively release each member individually, by simultaneously releasing the pneumatic pressure in the tubing only for the corresponding X Y coordinates of a given member or discrete sets while holding it for the others. Releasing the pressure on all tubings lets all the members descend, by the force of gravity, to their starting position, where the ends of the members configure a horizontal flat contour. While the membrane in Adamson is meant to be generally vertical in a given embodiment, in Page it is designed to be generally horizontal in the claims, although the description mentions it being possible to hang it on a wall specifically teaching the rubber sheet as the means to retain the members, also mechanical or magnetic means to lock the members, giving no further detail on their design or placement in the apparatus.

Hogan U.S. Pat. No. 5,793,918 A (1998) claims a plurality of optic fibers whereas the distal ends form a three dimensional image as each is positioned by a piston controlled by a computer mechanism that reads the position of the fibers.

Laskowsky et al. U.S. Pat. No. 5,796,620 A (1998) claim the use of conventional CAD/CAM software guiding servo-actuators to longitudinally position members held in a frame, a perforated plate, according to their x-y coordinates, corresponding to equivalent coordinates in the computer representation. They also claim plural actuators, plural such frames to form a box like enclosure. Each member has a longitudinally extending stem portion, a top end portion having a top end contour for forming a portion of the mold contour and a bottom end portion for member gripping and positioning. Members have an elliptical-shaped stem, so as to lock in the frame when rotated within an elliptical configured hole in the plate. The apparatus uses a liner, and/or not. That invention specifically is directed to lost wax or lost foam casting, teaching away from other practical uses. Fischer US2004/0159974 A1 teaches a two-part mold wherein each part is hemispherical in shape, teaching away from other shapes, and even other uses for a hemispherical pin assembly.

There has been much development in the art to shape, mold, machine, produce, and replicate three dimensional objects in a rapid and accurate manner. There is further need to advance the art when it comes to short runs, one of a kind pieces, displays, and other where an apparatus and method to produce three dimensional surfaces accurately and speedily is of advantage.

### SUMMARY

The present disclosure is accomplished in light of the above described circumstances, providing for method and apparatus to shape, form, and/or define a generally curve three dimensional contour surface and/or a three-dimensional contour surface as comprised in an object. In a preferred embodiment the apparatus comprises the contour of a portion of a plurality of members and of a portion of other elements, as well as actuator means and other elements and assemblies. In said embodiment members can be selectively unlocked from a starting position, intentionally displaced to a defined position, and locked in said position for further useful operations enabled in an embodiment.

These and other features, aspects and advantages of the present invention will become better understood with reference to the following drawings, description, and claims.

### BRIEF DESCRIPTION OF THE DRAWINGS

FIG. 1.—Isometric view of an embodiment.

FIG. 2.—Simplified schematic of a method for the purpose of casting

FIG. 3.—Side view of a matrix.

FIG. 4.—side view of a surface and members

FIG. 5.—side view of a surface and multi-part members

FIG. 6.—side view of a surface and members, where the surface is not at the end of the members

FIG. 7.—side view of a flexible membrane means and members

FIG. 8.—side view of a flexible membrane means and members, some of which are attached thereto

FIG. 9.—side view of a contour generated by jets of fluid

FIG. 10.—side view of a contour generated by an extruded material

FIG. 11.—side view of a contour generated by a continuous material

FIG. 12.—side view of a contour generated by a force

FIG. 13.—side view of a contour generated by members not in contact with each other

FIG. 14.—side view of a temporarily flat contour generated by members not in contact with each other

FIG. 15.—Several member shapes.

FIG. 16.—Several member shapes.

FIG. 17.—Cross section of sets of members.

FIG. 18.—Cross section of individual members.

FIG. 20.—Different configuration for members and their positioning constraints

FIG. 23.—Different member configurations and member shapes.

FIG. 25.—frontal view of members displaying method to unlock one member

FIG. 27.—An arrangement using muscle metal

FIG. 28.—Embodiment consisting of members of same length

FIG. 29.—Embodiment consisting of members cut to length

FIG. 30.—An arrangement using apertured plates with converging members

FIG. 60 is a simplified schematic view of an eccentric capstan actuator.

FIG. 61 is a simplified exploded view of the actuator showing a capstan, band, carriage assembly and support structure.

FIG. 62 shows a simplified assembly with three such actuators in different rotation positions

### DETAILED DESCRIPTION

While detail is given as to embodiments, elements or means, for the sake of example, the presence, or absence of an example or a drawing should not be construed as limiting the spirit and scope of the invention. What is recited is pertinent to an embodiment, method or product, or several, but should not be ascribed as part of every or all, as any use an element, function, part or step of different nature and design. While the disclosure hereinbelow with reference to certain embodiments, methods and products that the inventor considers in good faith to be novel and nonobvious, it is to be understood that there is no desire to limit to an embodiment, method, product, element, step, assembly, function, part, described or drawn as example to the exclusion of all and any valid modifications, alternatives and equivalents possible, as those skilled in the art will recognize as falling within the spirit and scope of the invention. Generally for the purposes of this disclosure the use of any expression among embodiment, method, product, or a combination, also includes use of any other expressions among embodiment, method, product, or a combination, when meaningful within the assertion.

Product, embodiment, method comprise: a generally curve contour; an object that includes a curve contour; an object shaped by a curve contour.

A contour comprises the general sum of a portion of the contour of a plurality of members. A contour comprises another element or elements attached or not to the members, not limited to: means connecting one member to another; a membrane or film; a layer of a material; a release agent; a demolding agent; a viscous substance; side walls; abutment or support means or assemblies; a force; any combination, and/or in an embodiment, none. In an embodiment said contour is generally flat from: the absence of the members; a starting or rest configuration of the members; a transitional configuration; or as the complement contour to a generally curve contour.

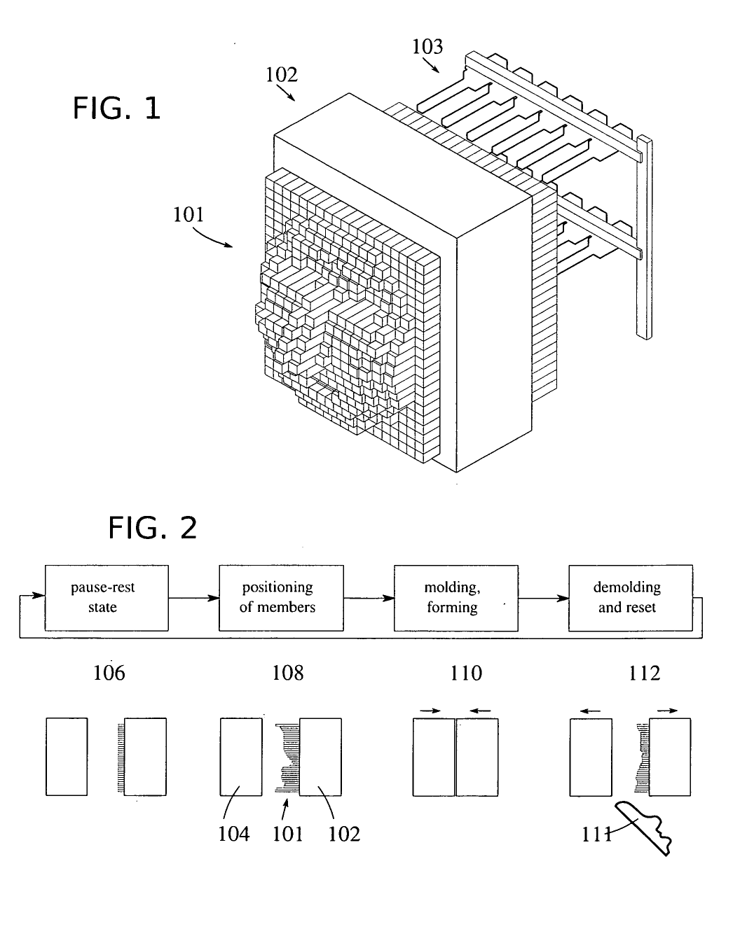

FIG. 1 represents schematically an embodiment, among many possible, a three-dimensional contour is defined by the proximal ends of an array 101 of members, supported by a frame 102. Also pictured is a positioning means 103, in this example an array of actuators.

FIG. 2 displays a simplified logic sequence of operations for an example of casting or forming a three dimensional object, the positioning means is not portrayed. Initially 106 the apparatus is at rest. The members are positioned 108 shaping a three-dimensional contour, in the example a mold for casting. The process of casting 110 is carried out, and finally 112 the shaped object 111 is removed, the members reset to the 106 starting or rest state. 101 is the array of members, 102 the frame, 104 other parts for casting.

A contour is a surface. A geometric plane intersecting the contour is a line, which is straight, curve, jagged, segmented, and/or any combination of these. A contour can comprise several contours.

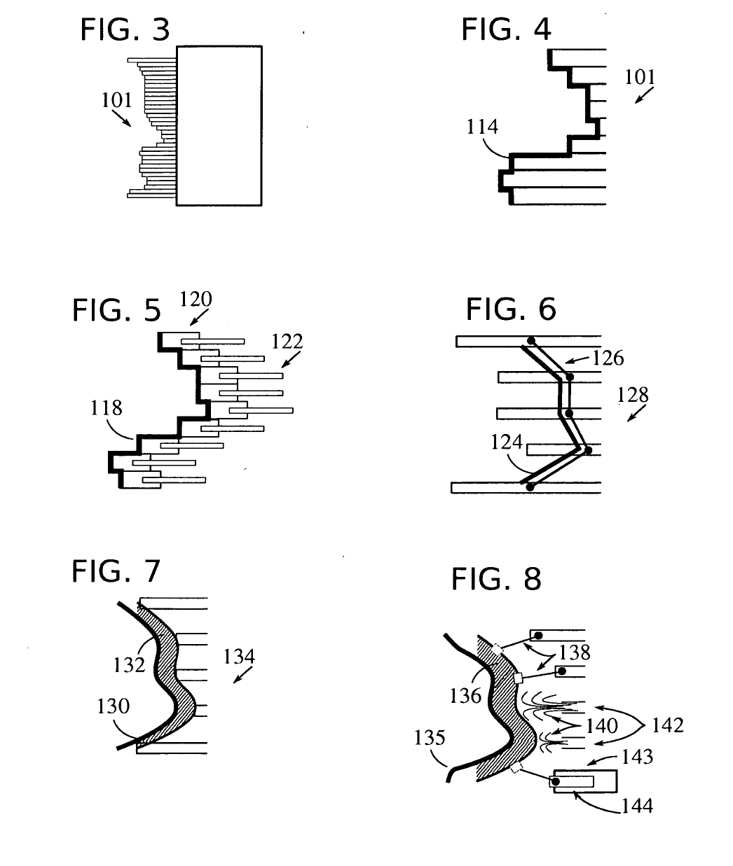

FIG. 3 a side view of a generic matrix, with members 101. A detail as FIG. 4 where a bold line 114 represents a generic geometric, non-material, three-dimensional contour, as defined by the sum of the contour of the ends and the exposed sides of generic members 101; seen in FIG. 5 as the contour 118 formed by the sum of the contour of the ends and the exposed sides of attachments 120 to multi-part members 122; FIG. 6 as the approximation to a contour 124 defined generally by connectors 126 between the members 128;

FIG. 7 by the proximal contour 130 of a plastic, flexible, and/or moldeable layer 132 shaped by hollow members 134 or FIG. 8 a working surface 135, contouring a flexible membrane means, comprising a layer, and/or a film, and/or foil 136, attached to a number of members with an assembly 138, and/or the layer is shaped due to a difference in pressure in a fluid 140 ejected from nozzles 142, and/or a force, in this case an electromagnet 143 actuating a magnetic rod 144.

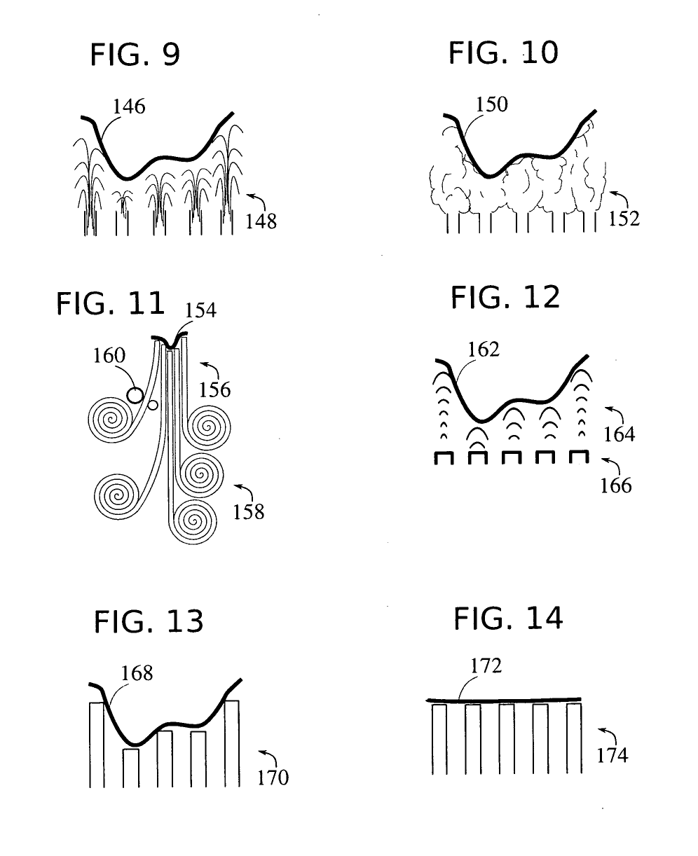

FIG. 9 portrays a contour 146, jets means or nozzle means 148 of fluid or material in plastic state, FIG. 10 a contour 150 an extruded material in plastic state 152, FIG. 11 a contour 154 comprising flexible rods, filaments and/or wires and/or other 156, in this example from reels 158. A method cuts or trims and/or shapes a continuous material to size, or not. A capstan means 160 to control the delivery of the material. FIG. 12 is a contour 162 generated by a force 164. 166 generically portrays any or several among controllers, emitters, deflectors, focusers, nozzles, for plasma, electromagnetic-spectrum forces, or a combination, including but not limited to radio waves, sound, light, ferrofluids, other fluids, and/or other force or material or a combination, whereas such force or material define to a meaningful extent a contour of the embodiment comprising a method of: directly, and/or resonance, and/or shock waves, and/or other. A member comprises material or a force or a combination thereof; pre-shaped, and/or shaped during use, as from a nozzle or other such suitable element 166. A member has one dimension longer than the other two, defining a major axis, whose length is generally identical to other members, or not, within a given embodiment.

FIG. 13 displays an approximation to a contour 168 comprising the ends of members 170. FIG. 14 displays a side view of a generic three-dimensional contour 172 as it circumstantially takes the shape of a two-dimensional plane in a positioning of the generic members 174, particularly but not limited to when the apparatus is at rest.

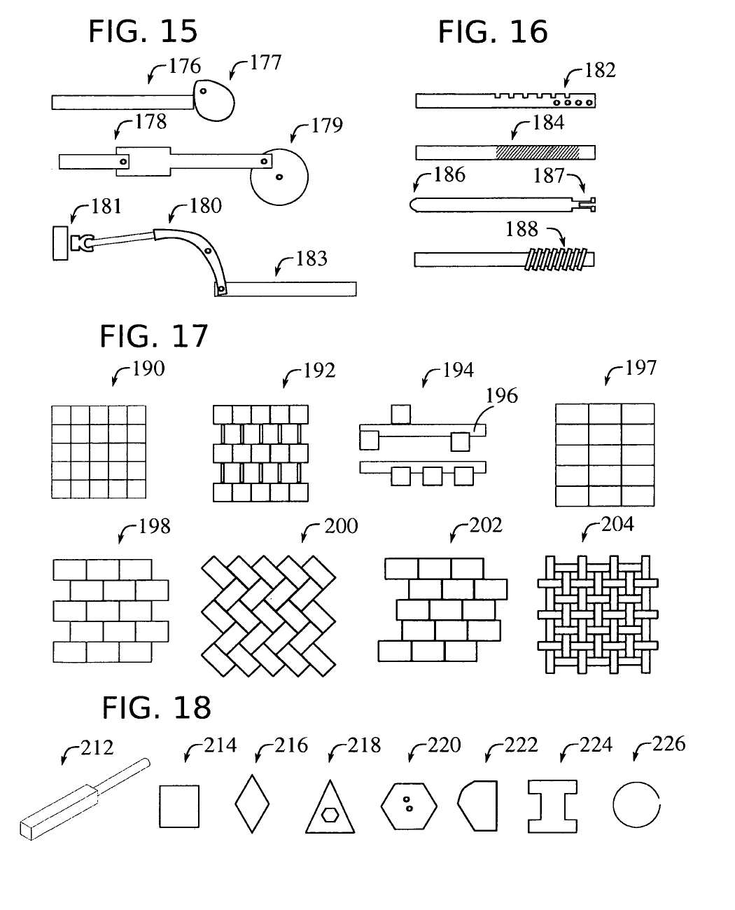

A member comprising attributes, one or more but not limited to the following: generally identical to others, FIG. 15; one single part 176; comprising several parts 178; in contact with other members FIG. 17 190; of at least one material; extruded; cylinder; a cone; a prism; truncated; right or oblique; generated ad hoc; of at least one state of matter; a combination of different structures, materials, materials with different properties such as flexibility, or curvishaped 180, comprising elements not physically attached or anchored to each other 181, by push, magnetism, friction or other. A positioning means comprises a cam 177, and/or a wheel 179, and/or another element 183. Be it understood that when a member is mentioned in this disclosure, for the sake of simplification other parts are not mentioned, described or portrayed individually or specifically, as descriptions of members generically as such also apply to such those elements, parts, assemblies or constructs. Part or all the sides and ends of a member is smooth 176, shaped, and/or finished, especially but not limited to FIG. 16 notched or perforated 182, knurled and/or coarse sanded 184, threaded 188, and/or an other scheme, for example to facilitate positional control, and/or locking in certain position, and/or increase friction, and/or finely polished, and/or to 186 define part of the work contour by means of a shaped face or 187 facilitate engaging the control mechanism.

As seen in FIG. 17, the cross section of members are of equal dimensions 190 respective to each other, and/or differ 192. Members are in full contact laterally with each other 190, conforming a tessellate contour, and/or at a regular 192 or irregular distance 194 from each other, where 196 is part of a frame or holding means the members. Other tessellate matrix arrangements include, among other possible, 197 where the rows formed by the members side to side are perpendicular to each other, as in the appearance of a stacked bond. In 198 the rows are displaced laterally by a same difference, as in the appearance of a regular running bond. A herringbone pattern 200. In 202 an irregular running bond section. In 192 the section of a number of members is square, while that of others is rectangular. Basket weave 204, is an example among many other possible of an incomplete tessellation leaving partial spaces between the members.

A member comprises different section, shape, dimensions or material or finish along all its length or a part of it. An orthotope, parallelepiped or rectangular prism as the three-dimensional shape 212 is part of a member with two different cross sections in FIG. 18, where the cross section of the work contour element 214 thus would be square. Cross section shapes comprise rhombic 216, triangular 218, hexagonal 220, round 226, regular or otherwise or combination 222, this being just an overview of possible section shapes for members or member parts, not being the intention to teach away from other possibilities. In an embodiment there might be considerable advantages to the use of certain complex shapes, as 224 is an example of an “H” section, for either a partially interlocking tesselation or an arrangement where a channel between the members is left open. A cross section in any axis of a member is full or hollow, with one or more than one such invagination, which may be partial or complete conforming a tube, parallel to the main axis and/or start in one face and end in another and/or the same face, and/or branch inside the member, cross section 218, 220.

The material of a member or part of a member comprising, at least one of the following: homogeneous or not; of at least one of: any manufactured or natural material, plastic, metal, magnetic or not magnetic, wood, stone, clay, a resin, particulates, a fluid, a fiber; optic fiber; a wire; a strand of material; a roll of material; a plastic material, a flexible material, a resilient material, a solid material, a material that changes state prior, during or after use, changes color; other;

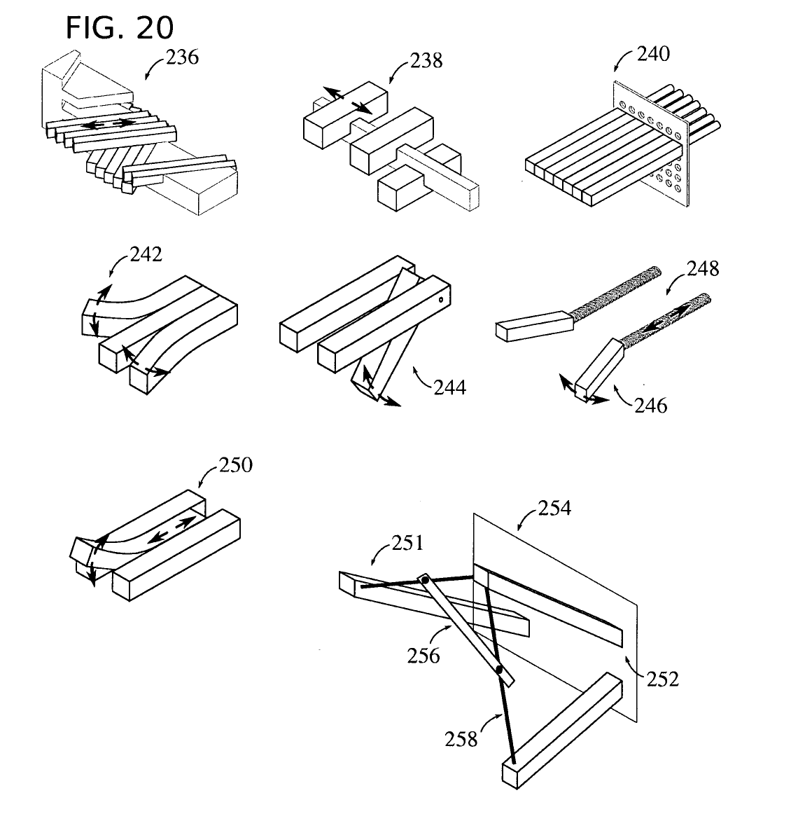

FIG. 20 an individual member or member part occurs obliquely 236 in a given embodiment. Notice that the members of a subset are generally parallel among each other within a given row, but not necessarily parallel with members within another row. Imaginary lines drawn along any two rows are parallel or not parallel, and/or parallel in one plane and not parallel in another plane. Said arrangement changes during use in an embodiment.

Members positioning comprises slide in parallel 238, and/or perpendicular 240 to the reference plane of the frame. Notice a row of members parallel to each other within a continuous row and not at the end of said row make lateral contact of at least 50% of their length with at least two other members.

A member bends 242 or tilts 244, and/or rotates 246. Members and member parts intended to tilt and/or rotate and/or translate do so in reference to a fixed or movable point or axis, in an embodiment these corresponding also to translation 248 250 or rotation or tilt themselves, parallel, perpendicular, and/or at an obtuse angle in reference to the framework, and/or any of those geometries in reference to the main length or main axis of the member.

Members 251 attached or anchored 252 to a frame 254, and/or not 256, in this case connected to other members by guylines 258. Those comprise passive, and/or elastic, and/or spring, and/or active, and/or other, as for example when made of muscle metal.

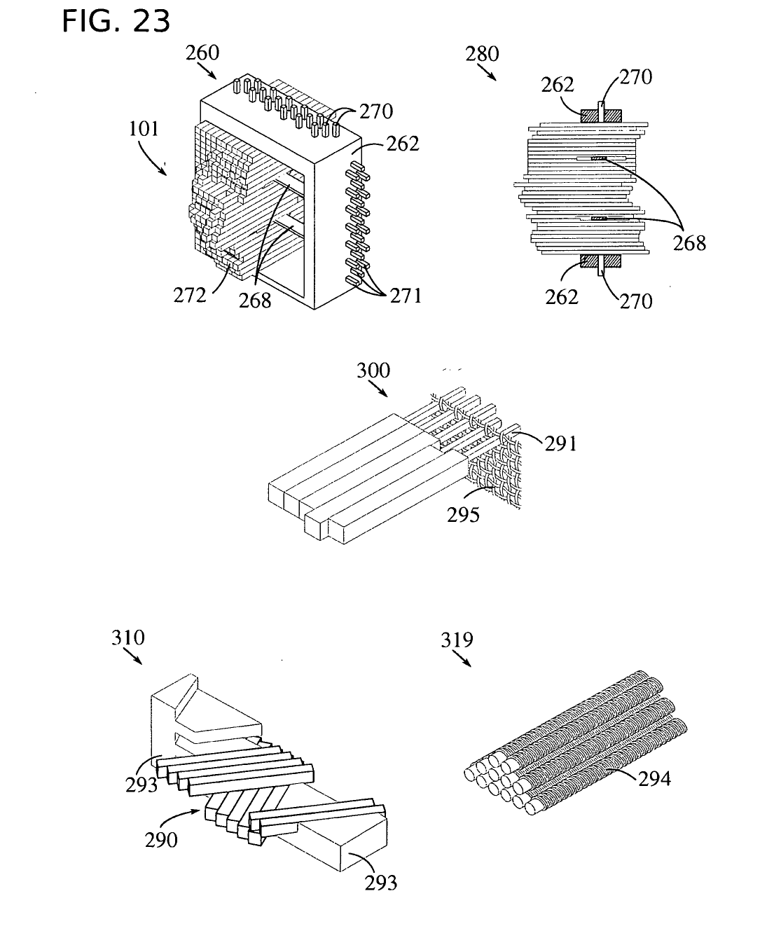

FIG. 23 displays a number of parts of matrices and arrays. Many members are not represented so as to allow a better view.

260 portrays a matrix in isometric view. 262 points to the external frame, with supporting braces 268. 270 indicates a number of quoins for column lock, 271 to a number of for row lock. 272 point to a member, part of an array 101.

280 is a side view cut of a matrix. 262 is the frame, 270 quoins, 268 braces. An array of members has a number of members with a shape designed to slide over or under a brace 268.

Each member in 300 comprises two parts, this time both parallelepipeds. The distal part 291 fits in a grate 295 comprising metal wire and/or plastic and/or a fiber and/or another material.

In 310 the major axis of members 290 is at an angle in reference to the contour represented by the frame 293. Members are set in rows where the angle of the members is same for those within the same row, but different from the angle of those in another row.

319 represents member 294, threaded, forming an hexagonal pattern in cross section. While 260, 280, 300 and 310 are tessellates, in 319 the members have gaps in the working contour. Such threaded members are stacked as the example pictured in 319, and/or be threaded within apertures in a plate, for example.

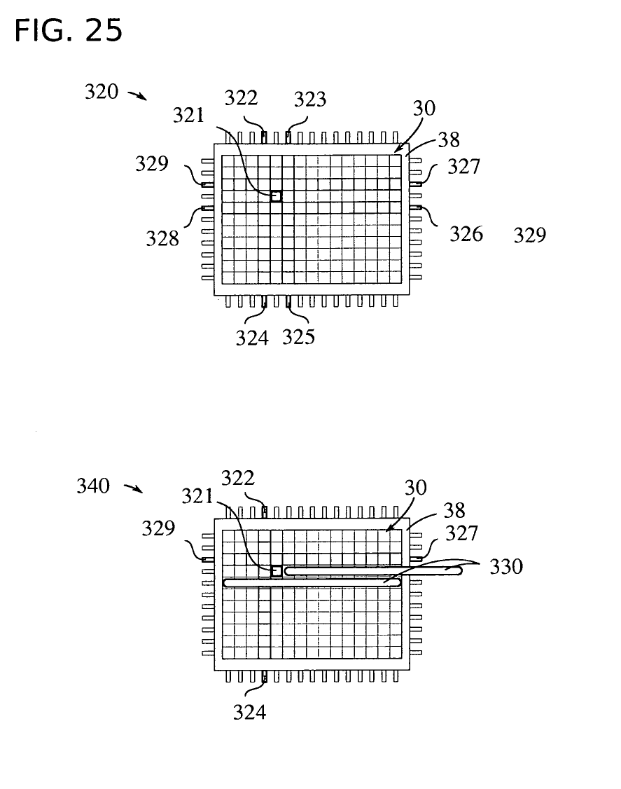

FIG. 25 shows frontal views of a matrix, displaying the differences in operation were it to have extra elements 330 to lock the movement of members. 30 is the array of members, 38 the frame.

During the operation of setting the members, member 321 is to be positioned by a linear actuator pushing the distal end.

in example 320, column quoin pairs 322 and 323, and 324 and 325, and row quoin pairs 326 and 328, and 327 and 329, lock members in the corresponding columns and rows.

Differently, in example 330, only column quoin pairs 322 and 324, and row quoin pairs 327 and 329, lock members in the corresponding columns and rows. Members 340, designed to translate laterally in reference to the array, block the forward movement of those other members in contact with the member being set.

A matrix comprises a plurality of members. The matrix also comprises, or not, a frame consisting of single or plural parts, elements or assemblies as means to support the members; and other elements. An embodiment comprises one or more matrices, generally identical, and/or different from each other within a same embodiment. In an embodiment a matrix is fixed, or movable and/or removable.

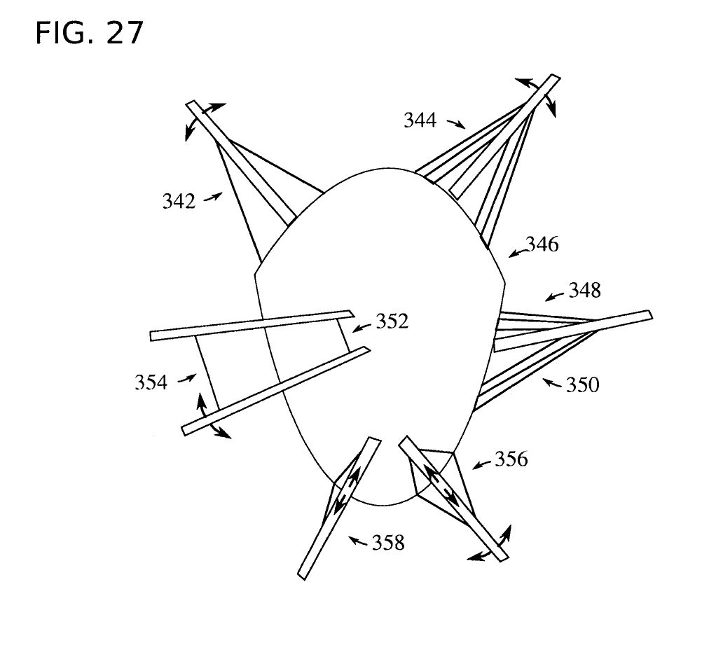

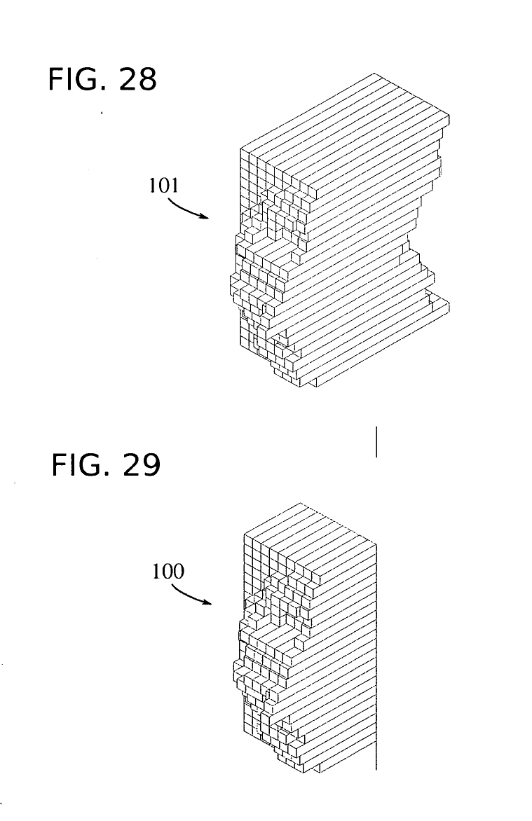

An arrangement of muscle metal, suitable for control of members, is portrayed in FIG. 27. In an embodiment a number of wires is replaced by a spring. Muscle metal wires are set as singles 342, and/or multiples 344, attached to each member. Members are in this example anchored to a curve contour frame, shown in section 346. 348 portrays a set of wires that has contracted, while the opposite set 350 is extended. Be it noted that not all wires need to be actuated simultaneously, selective actuating gives more precise control and force. Depending on the particular muscle metal, either the contracted or the extended state is the actuated state. Wires connect between one and other member, contracted in 352 and extended in 354. Of note is that both ends of these members extend away from the frame, and it pertains to an embodiment if both tilt or one is laterally fixed. Example 356 and 358 portray translation movement, where 356 can also have tilt control. FIG. 28 and FIG. 29 display an embodiment consisting solely of members 101, with no frame or any other part. In FIG. 28 the members are all the same length. In FIG. 29 they are all cut to size. Members are cut to size previous to being positioned, and/or the whole matrix trimmed after the members have been positioned and bonded together.

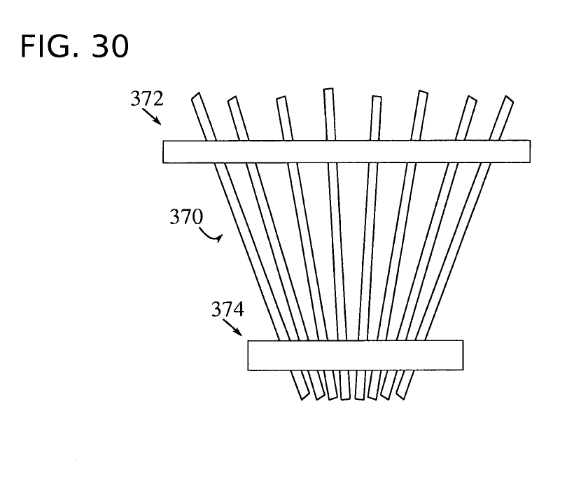

FIG. 30 displays an embodiment using apertured plates with converging members, where said members are not parallel to each other. 372 and 374 are apertured flat plates, 370 is a set of converging members.

An embodiment includes a novel band drive actuator where the motor shaft is in an eccentric position respect to the center of the base of the cylindrical capstan. The center of revolution of the shaft and the capstan are parallel, but not identical. In the novel band drive actuator the linear movement of the extension of the member is not directly proportional to the rotary movement of the motor shaft and the position of the member is generally oblique to the movement of the linear actuator and an attachment to the carriage exists possessing an assembly to selectively and temporarily secure other attachments. Due to the eccentric position of the shaft respect to the capstan, variations of the extension of the band at any given moment of rotation will be approximate proportional to the distance in the capstan between the center of rotation of the shaft and the point where the extended member makes tangent contact, this distance being variable as the eccentric capstan rotates in response to the motor, with an additional variation resulting of the angle of the member respect to the movement of the linear actuator.

A member is attached to a band, and/or flexible element, that is attached to and wound on a capstan, or, a member is driven longitudinally by frictional action by a capstan.

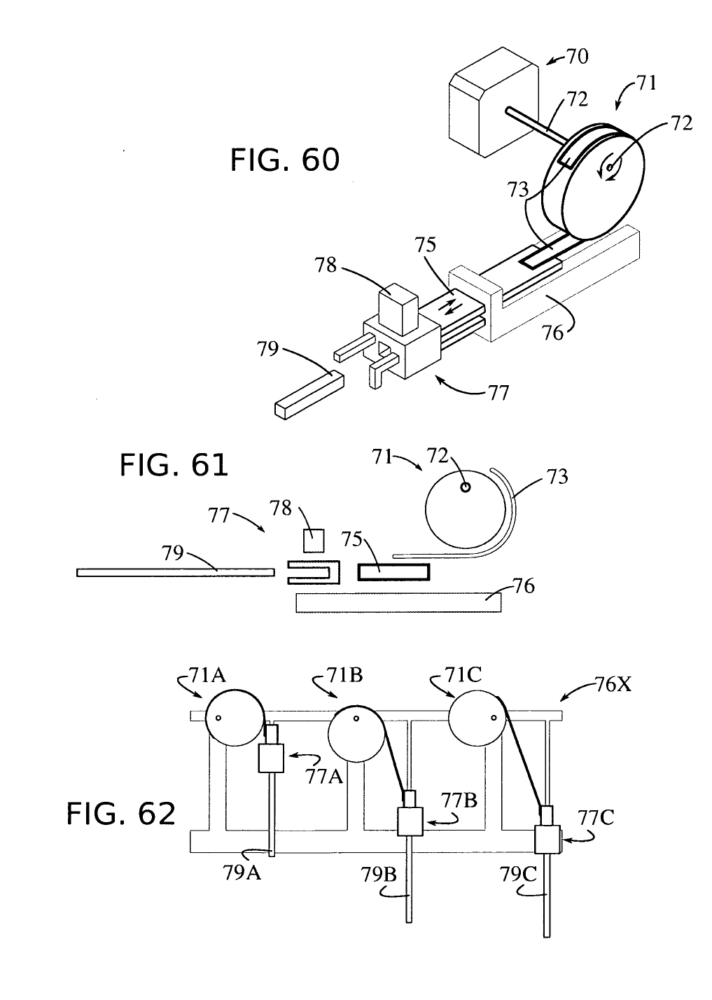

In FIG. 60 there is a motor 70 connected to an eccentric capstan 71 by means of shaft 72. The proximal end of a flexible thin band 73 is attached to the capstan 71 and the distal end is attached to a carriage 75. The lateral movement of the carriage 75 is constrained laterally and guided for longitudinal movement by a support structure 76—a simple rail system is shown, nonobstant other arrangements possible. The movement of the carriage is shown occurring in the direction of the extension of the member. Its placement can be inverse, that is, to position in the opposite direction, being furthest when the member is coiled. An attachment assembly 77 to the carriage 75 is shown, which can have parts with different shape, design or function. A control mechanism 78 is present for the purpose of selectively securing additional parts 79.

FIG. 61 comprises an exploded, schematic view of several parts of the actuator. An invagination is shown within a element in the attachment assembly 77, which could be one among many embodiments possible for a mechanical, magnetic, and/or other method to secure an additional element 79 by the means of a control mechanism 78.

In FIG. 62 an assembly of three such actuators is shown, each one in a quarter-turn different angular position of the rotary moment.

Another proposed novel embodiment of a band drive actuator sets the motor shaft oblique to the center of revolution of the capstan (not portrayed). In some assembly this achieves both lateral and forward movement, among other. In an embodiment, the capstan is replaced by an articulated arm.

The placement configuration of members in a matrix comprise, not limited to the following for example at least one of: random; generally parallel to each other in a row; those parallel to each other in one row, oblique to those in another row; a row following a straight line; a row following a curve; members in a row sharing a common rotation axis; in contact with each other; separate from each other; connected to one or more members, and/or not; attached to the frame, and/or not; other; or any combination.

In an embodiment with a frame, a member is attached, and/or supported by, and/or generated by an element in the frame. In an embodiment a number of members are anchored to a frame, and/or other members and/or member parts can be positioned closer or away from the frame during use. Member holding means comprise the frame, and/or elements attached to the frame and/or others.

A frame comprises: sides enclosing the members; cross braces in one or several directions perpendicular to the generality of members; other support elements; other elements for direction the members means, including but not limited to wedges, rails, other.

For the purposes of discussing the parts and elements of an embodiment we define framework as a geometric notion. In a number of examples of a matrix this generally is a plane, in others a curved contour. Generally the framework is determined by the proximal ends of the members, and/or by a point within the members, and/or by attachments to the frame, which in itself is not part of the matrix. As non limiting examples of the general shape of the framework, one of: a human head; an object of nature, included but not limited to terrain; an object of manufacture; a flat surface; a curve surface; an aerodynamic surface; a hydrodynamic surface; other; a combination.

Actuating members into position means comprise, not limited to the following at least one of: set in position; set at position; translation; rotation; transformation; bending; tilt; from a starting position; into a starting position; from any other position; into any other position; slid along the major axis; rotated along a major axis; slid along any axis; rotated along any axis; twisted; reshaped; produced to a certain dimension; other; any combination. In an embodiment the members are repositionable many times. In an embodiment the members are locked in a displaced position, either momentarily or permanently. Translation of an individual member or member part occurs at an obtuse angle, and/or parallel, and/or perpendicular to the reference plane of the framework, and/or it moves, tilts, and/or rotates axially in relation to a point in the framework or to another member part. Members or member parts intended to position along their major axis does so generally parallel to each other, and/or convergent to each other, and/or another arrangement, regularly within sets that differ from each other, and/or be the same for all of a a given matrix, and/or in different directions and combinations, as corresponds to a given embodiment. Members or member parts intended to rotate around a fixed axis do so parallel, perpendicular, and/or at an obtuse angle in reference to the framework, and/or to the member main dimension, or other.

An embodiment comprises means for actuating at least one of: the members; the matrices; other parts; or any combination of those, and/or none. In an embodiment a number of parts of an apparatus, including whole matrices, are detachable from the apparatus. An embodiment comprises temperature means, and/or force and/or power control means, and/or sensor and feedback means.

An embodiment comprises any combination comprising numeric control means: including but not limited to at least one of: CAD/CAM software, feedback means comprising sensors; microcontrollers; microprocessors, computer, computer means, data transmission means, power means, numeric control actuator means, other means as are evident to one familiar with the art. A virtual representation of the embodiment and/or parts or the resulting contour by a computer or other art comprise means of preparation and/or connection, and/or response and/or feedback, comprised or not the control means.

Actuating means and positioning means comprise for example at least one of: memory metal; solenoid; a linear actuator means comprising a screw thread coaxial with a motor shaft; a linear actuator means comprising an arm actuating perpendicular to a motor shaft; a capstan actuator; a piston; an expansion body; pneumatic; hydraulic; a jet; compressed air or another fluid; a threaded element; a ratchet assembly; a screw and nut assembly; a lever; a cam; direct pressure resulting from urging an object unto the embodiment; a rotating actuator; elements and means to transfer movement to the member; elements and means to transfer force to the member; gravity; thermal difference; chemical reaction; vibration; electromagnetic spectrum frequencies; manual; electromagnetic force; a fluid force; comprising a digital computing means; comprising an analog computer means including but not limited to mechanical transfer; comprising a pantograph means; other; any combination; other.

In all embodiments of haptic devices for the visually impaired, resetable members comprise more than two possible stable positions.

A quoin is an element or assembly that exerts pressure laterally unto a plurality of members and other parts, means to selectively lock or unlock said members. An embodiment comprises at least one quoin for each line set as a row or column of a matrix of generally parallelepiped members. AN embodiment uses quoins for certain lines only and not for others. An embodiment does not use quoins at all.

Members locking into position means comprise, at least one of: quoin means; high viscosity; magnetic means; bonding means; release of a spring means; members having one or a plurality of apertures penetrated by a cross pin; an apertured element being displaced laterally to the members; and apertured element being displaced obliquely to the members; an apertured element being displaced vertically to the members; an element being displaced laterally to the members; and element being displaced obliquely to the members; an element being displaced vertically to the members; any of those indicated among actuating means; other; any combination.

An embodiment comprising magnetic means for locking comprise: corresponding members wherein a portion less than 49% by volume of each member is magnetic.

An embodiment comprises other parts and/or means necessary for the particular purposes of said embodiment. For example, an embodiment where a contour serves as mold or part of a mold for injection molding will also need parts and means particular to the art of injection molding, including but not limited to high pressure extruder, controlled heat vessel, means to cool the assembly, others. As another example, an aggregation of wood members that form a three dimensional object, for example, a sculpture, where the jagged edges of the surface be sanded, polished, varnished and suffer other methods and procedures pertaining to the art of sculpture and wood carving.

The size and shape of the members, matrices, and other parts reflect the size of the objects to be manipulated. Definition and precision of detail is usually described in the printing arts as “dots per inch”, measured as the number of individual dots that can be placed in a line within the span of 1 inch. In an embodiment with a tessellate of orthogonal members, this roughly is the inverse of the width of their section measured as a fraction of an inch. That is, members where the end that forms the contour measures 1/10th of an inch wide will produce results that can be described as “10 DPI”. This measure can be different if the section is irregularly shaped. Embodiments producing garden sculpture does not need high precision, operating in an acceptable manner within 1 DPI, producing objects several feet across. Other embodiments, meant to produce delicate, miniature pieces, are designed for 100 DPI or higher, and each matrix is only a few inches across, and/or even less.

The speed of generating a shape is roughly proportional to the number of actuators available and their speed. In embodiments where each member is powered by its own actuator, forming a shape is very quick. An embodiment will have a limited amount of actuators, mounted in one or several arrays, an embodiment even fewer or only one, or none. In an embodiment where actuators need to be aligned with each member that need be displaced the overall production speed will be affected by the speed of the assembly that relocates the actuators. Embodiments able to provide high precision, with high DPI, meaning a large number of members, will complete a same-size shape slower than those with a smaller number of larger members when the number of actuators is the same.

While tessellate geometry arrangement of orthogonal members is one of the simplest constructs for a matrix, the contour achieved is not smooth, but is jagged, constituted by “steps”, as the three-dimensional equivalent to a highly pixelated picture. The use of an in-between flexible layer, a plastic film or a metal foil, and/or a layer of a demolding agent can produce some smoothing of the contour, as also can a flexible layer attached to the ends of the members.

A flexible layer provides the working contour: the members position and shape the layer from underneath, and thus the three-dimensional work contour is formed. Depending on the characteristics and flexibility of the layer, this arrangement not only rounds the contour, it also allows for a lower per inch concentration of members for a given-size object, since the intermediate positions are filled by the layer, and members need not be tessellate in cross section. The outside of the layer is finished to a gloss, and thus objects molded therein will take that finish—or any finish deemed desirable, such as orange peel, a corporate design, and/or any other. The layer is connected to single-piece flexible members, and/or with anchors in the layer, attached to the shaft of multi-part members by an arm, ball-and-socket, and/or other suitable arrangement.

In a number of haptic and visual output uses, a fast-responsive contour is an even more important goal than it is for molding or shaping. An embodiment could retain the general aspect described above, of a generally two-dimensional reference frame within which multi-part members are set in given positions, their proximal ends attached to a flexible layer or not. a number of members in these embodiments would rotate or tilt, rather than translate. Among other practical uses, a flexible layer contour can represent terrain, as a visualization aid for education in geology and topography, land management, and military planning, or an embodiment pertaining to airfoils, hulls, and other aerodynamic and hydrodynamic dynamic contour control. Contour control does have applications in sound and other wave and force control, and/or control of the flow of materials in one or more of: flues, ducts, resonant horns, other. Be it understood that tessellate designs can also be used in any of those fields and purposes. In an embodiment, pairs of members or more complex constructs comprising one or more layers connect with each other from both sides of a layer. An embodiment does away with the material flexible layer altogether, being constituted merely by interconnected members that define a contour.

An embodiment resembles in its outward appearance an object of nature or industry, for example a human face. Among others, comprising one or more of the pull of muscles is simulated, grimaces, smiles and facial expressions, and even the appearance of speech, actual simulation of speech organs, a closer representation of reality, and/or for shapeshifting special effects.

An embodiment represents three dimensional surface contour defined through polygonal modeling, comprising a mesh of vertices and/or points and/or faces and/or edges. Were the proximal ends of members connected to each other, for example with a flexible or stretchable material, their displacement produce a material polygonal mesh. An embodiment represents a material three-dimensional surface merely by certain point or points physically manifested or geometric in the members, comprising the end of the member, a point within the member. In an embodiment these are shaped differently, and/or illuminated, and or of different color, and/or another feature to make them stand out, if so desired.

Besides the use of digital electronic positioning mechanism and actuators, a matrix in certain embodiments can be set in a three-dimensional shape by analog means. A vibrating element can be present. One method is as follows: the frame is set parallel to the floor, members unlocked for limited free movement of the members, while they keep their general position in reference to each other. The matrix is then urged over the object wherefore the shape is to be copied. Gravity or another force will get each member to fall in position, where the end of each member touches the surface of the object. There being a vibrating element, it will help this be accomplished. Once the user is satisfied of the result, the frame is tightened again. Locking of the members is achieved by quoins, side pressure, a drilled plate, and/or other element, and/or a bonding agent such as glue or other, and/or heat, where the members weld to each other. Were all the members to be parallel and of the same length, the proximal ends will produce a hollow, concave approximation of the contour, while the contour corresponding to the distal ends will be an approximate three-dimensional likeness of the object.

In an embodiment each member is corresponded with a spring and does not depend of the force of gravity as means to position the members when an object is urged, for example, laterally, or downwards, whereas each member is displaced according to its point of contact and the shape of the object, as the spring forces the member in close contact with the object. The members are locked, the embodiment now contains a likeness surface to the object.

An embodiment designed thereto for rapid fabrication bypasses a constraint common in the current state of that art, comprising: virtually any material used in molding and casting can be cast or molded in an embodiment, either directly, and/or using an embodiment to shape a mold. Layered deposition material of conventional 3D printing provoking a loss of strength is no longer an issue. Pouring also facilitates casting and molding clear, transparent solid objects. A noticeable gain when comparing to current technology is expected in the speed of the process: whereas in conventional layer deposition hundreds to tens of thousands of layers are required, an embodiment will achieve similar three dimensional objects with one single stage of positioning the members and other steps. An embodiment designed for a purpose is not necessarily suitable for another purpose, while some cross use is possible and is neither claimed or disclaimed.

Where an embodiment shapes a pattern as for casting, it can be used for example and not limited to, cope-and-drag mold-making, vacuum molding, DISAMATIC—an automatic production line used for fast manufacturing of sand molds for sand casting, and/or any other art where a mold is shaped on a pattern, be it a single-piece mold, or a two-part mold, or complex molds with several parts.

Where the shape formed defines a mold, an embodiment can be used directly to shape other materials. An embodiment is suitable for at least one of: embossing; injection molding, including materials or combinations that are thermofusible, thermosetting, chemical setting by polymerization or other, settling or other physical deposition, and/or metal alloys, suspensions, particulates, solid, fluid or plastic materials; vacuum forming; electrodepositing; other; or a combination, this being a non definitive list. An embodiment will be designed to higher tolerance to heat, and/or chemical reactions, and/or better demolding schemes, and/or according to the kind of material to be shaped and/or the method; an embodiment will be designed with less expensive materials to lower costs. In an embodiment, once a shape is achieved, it can be used as a mold many times, a replacement for injection molding, not limited to unique pieces or short runs.

Besides creating shapes and objects, certain embodiments are able to fabricate copies in quite fast turnaround processes, sometimes using analog technology. An embodiment in some ways mimics current multi-function peripherals that print, copy and scan flat documents, this time regarding three-dimensional objects, and even procure enlargements and reductions in size, by direct urging of an object into certain embodiments, and/or indirectly by using sensors and interpreting such data, and/or other means, in an embodiment comprising digital means.

Visual output embodiments enable useful information and education displays, and/or effects where 3D is no longer virtual, but actually can be seen, perceived, even manipulated as real objects, according to the embodiment.

As to haptic output, its use certainly is not limited to the needs of those of impaired or limited vision, but can also be of practical application in a number of fields. Visual and/or haptic output can be useful in at least one of: education, entertainment, military, design, visual arts, performing arts, consumer electronics, industrial tools, for design, research, quality assurance, other.

In airfoil, and/or wind energy parts, and/or aircraft and/or watercraft surface design, among others, a controlled surface opens opportunities for manipulating efficiencies and performance when it comes to controlling the flow of fluids, and/or particles, and/or forces. When the contour results from a generated force, its actual applications might be beyond current perceived needs, as nothing of the sort was commonly available to this date, but let it be surmised that many industrial processes where a controlled thermal an/or electromagnetic contour, this contrasted to merely a controlled jet or beam, would benefit—from influencing other processes of rapid fabrication, and/or up to and beyond weather control, and/or medical and remote sensing applications. Precise industrial control of flow of materials will also benefit from a suitable embodiment.

Of course the above is merely a brief recount of a number of fields of practical use, among many other possible and new ones that will be enabled by the invention.

Any grouping of descriptions of an embodiment does not imply an intension inclusion or exclusion to the detriment of any other embodiment

an embodiment of a three dimensional puzzle wherein generally long members of a definite size, color and material are placed sequentially, in a predetermined placement position or one defined by the user, the end result being a solid three dimensional object of a definite shape. The three dimensional contour resulting from the contours of the distal portion of said members, the proximal being generally flat, and/or contours opposite each other both being a three dimensional contour. Furthermore, an embodiment might allow for dismantling said object. An embodiment might comprise aggregation means, permanent or temporary, comprising at least one of a bonding agent such as glue or other, a high viscosity substance, heat, a substance that reacts to heat or cold to cause bonding, and/or another, either on the external contours, and/or soaking into the matrix in part or completely. An embodiment comprises sanding, painting, other finishing means or a combination to achieve, at least one of: a smoother surface, a more pictoric surface, and/or weatherization, other. An embodiment comprises a frame to hold the members. In one embodiment a frame is box-like in appearance and comprises printed markings to facilitate placement of the members. An embodiment comprises several frames marked to help place each individual layer. An embodiment comprises marks in each member to facilitate its placement. An embodiment does not use a frame at all, and consist of only the members. In an embodiment the members are parallelepiped, and/or of other prism shape.

An embodiment comprises members where at least a lateral side is also shaped away from a flat surface. An embodiment comprises different members or member sets in a given placement position to achieve partial variations of the completed object, these differences being, among others, one or more of size, color, material, cross section.

An embodiment comprising a matrix of same or different-length parallelepiped members square, rectangular, hexagonal, and/or any full or partial tessellate shape in section, held parallel within a frame where they can slide lengthwise against each other and the frame, temporally locked in its starting shape by the presence of a viscous substance, and/or other temporary lock means, and or free.

For example, were the viscous substance become less viscous by means of heat, and/or vibrating means and/or other means to facilitate the individual members to displace, and/or manual urging are among those comprised by a method.

In an embodiment, the contour has a removable substance applied, which hardens to a generally solid or flexible state conferring a shape comprising but not limited to a face mask. In an embodiment, the matrix is cut perpendicular or oblique to the members, so as to shape a flat contour opposite the three dimensional contour achieved, and/or parallel, creating a sort of multi part puzzle.

One among several practical applications of an embodiment is to copy a three dimensional object without contaminating it, a desired feature in fine arts sculpture, historic preservation, anatomy, among other arts which are evident to one familiar with the art.

An embodiment comprising at least one string, thread, wire and/or another continuous, generally solid or plastic material that is segmented to size or not prior or after being placed in position to form a matrix of generally parallel members generally in contact with each other. The embodiment comprises one or a plurality of nozzles that deliver said material. Said material comprises homogeneous material or different materials, for example, of different colors. Once the members have been placed, the resulting matrix is aggregated. An embodiment extrudes measured segments of ceramic or polymer clay or some other material including but not limited to aluminum in a paste-like state forming a matrix that is fired afterwards or not, including or not further processes to finish the surface.

An embodiment involves a shaft that is displaced selectively locking the movement of members, freeing only one member at a time. This shaft is placed in front of the members, and/or across member notches, and/or though apertures in the member.

As necessary, an embodiment or method comprises vents, pockets, ejection pins, sprue, and such as usual in the art of casting.

A controlling mechanism operates from the distal side of the contour, and/or from the proximal in reference to the contour, according to an embodiment. The frame is perpendicular to the ground, and/or parallel to it, and/or at an angle, there being advantages to each that need to be balanced against the disadvantages, as best fits a given embodiment.

A method for casting comprises, one or more of: applying one or several layers of any among: paint, finishing, a demolding agent, particulates, pre-heat, another preparatory operation performed, a combination. Parts and processes familiar to one of ordinary skill in the art of casting are not described.

A person with ordinary skill in the art can understand how method and embodiment disclosed can achieve, with modifications as necessary, one or several among: blow molding, vacuum forming, thermoplastic or thermosetting resin casting, chemical setting deposition, electroplating, molten metal casting, including but not limited to multi cavity molds, sandwich, use of an injection ram, a centrifuge, and other.

An embodiment or method will produce patterns that are then used to form the core of casting molds, according to the corresponding art, be it sand casting or other, as it is particularly desirable to avoid undue stress in an apparatus, for example due to high temperatures and pressure involved in metal casting and injection molding or other, and also to produce repeat identical molds. Moreover, let it be mentioned that in the case of parallel same-size members both a “positive” as well as a corresponding “negative” shape contour is formed, one being suitable as a pattern, the other a mold, according to an embodiment.

A person with ordinary skill in the art understands how the use of plural matrices is related to using plural mold plates in conventional casting, of particular interest for complex objects, and hollow ones, offering advantages and challenges.

an embodiment with two corresponding, facing matrices allow quick-turn embossing of sheet materials, be it by pressure, and/or vacuum forming and/or other means, in an embodiment the members in one of them are set with a positioning means, the other set as an analog copy achieved by pressing the former face-to-face.

An actuator comprises a muscle metal or shape-memory alloy, copper-aluminum-nickel, and/or nickel-titanium, and/or another SMA composition, for example those sold under the trade names of Flexinol or Nitinol, replacing a number of or all motor-based actuators in an embodiment. The muscle metal is set as single wires, and/or as arrays, and/or in complex arrangements and steps meant to achieve higher precision and detail. SMA-based actuators are set to pull and/or push.

An actuator comprises electromagnetic punch, and/or or solenoid actuators

The actuator in the controlling mechanism displaces the member to its intended position, either by pulling or pushing. The quoin corresponding to the particular column is tightened, and another one released as the actuator lines up with another member, and the cycle is repeated.

### USE OF THE INVENTION

The industrial and/or other application of an embodiment comprise directly the shape of a contour and/or further operations that benefit of the contour or contours.

A non definitive list of practical applications comprise at least one of: form, deform, shape, cast, mold, haptic output, visual output, control of material flow, control of force.

### Preferred Embodiment

A description of an example embodiment, its uses comprising casting plaster objects.

An embodiment comprising members set in parallel rows and columns. A positioning mechanism comprises actuators, moving on a rail assembly, sweeping through rows and columns, carried by a belt, rack and pinion, screw mechanism, a combination, and/or other variation usual in XYZ mechatronics art. As an actuator faces any given member, the quoins for the corresponding row and column are released, while tightened for the next and previous row and columns—thus the particular member has a limited freedom of movement, but not its neighbors.

The embodiment comprises a single matrix; 625 orthogonal, square-section acrylic members, within 0.5% tolerance of 0.22 in wide and thick, about 5 in long, set in a generally continuous tessellation of 25 straight rows and 25 straight columns; a frame surrounding the members where each row and each column comprises one quoin assembly, for a total of 50; an additional assembly that comprises a box; an additional frame; other elements.

The frame is generally rectangular in shape, its maximum dimensions about 7 by 8 inches. It comprises an apertured plate with rows and columns of apertures 0.2 in in diameter, each corresponding to the distal end of a member. A 0.2 in magnet is permanently attached in a precise location of the frame. The plural quoin cam shaft is attached to the frame.

The additional box, corresponding to the proximal end of the members, has internal dimensions of 5.5×5.5×4 in, and comprises a surrounding frame that aligns it with the frame. The box is not permanently attached to the frame, but can be fitted in position or removed easily, urged manually to achieve adequate tightness to the frame.

Likewise the additional frame, where are attached member position means, actuator positioning means, quoin lock and unlock means, and digital control means, fits precisely on the frame.

The member position means comprise: two rows of 3 actuators, attached together in a movable carriage on X-Y rails, sliding in either the X or the Y axis at will of the actuator positioning means; the actuators being linear, each comprising a Nema 17 step motor, a threaded rod, coaxial and attached to the shaft of the motor by means of a semi rigid piece of tubing, and a corresponding threaded hollow shaft, whereas rotation in the motor causes the hollow shaft to displace parallel to the motor shaft axis, that is, in the Z axis, the hollow shaft being impeded from rotation, and forced to slide along a rail, each rail attached to an apertured plate perpendicular to the rail, whereas the distance between apertures in said plate is 2.88 in the Y axis and 1.76 in the X axis, and the size of the aperture 0.11 in; A 4 in cylindrical rod 0.1 in diameter continues the proximal end of each hollow shaft, and is partially sharpened in its proximal end. The assembly is set in such a way that when the step motor rotates, the rod slides along one corresponding aperture in the 3×2 apertures plate, and then penetrates one aperture of the plate in the frame. As it keeps advancing, it pushes the corresponding member forward, the amount of displacement corresponding to the number of rotations that the step motor has run.

The actuator position means is a similar assembly to that of the member position means, that is, each comprising one step motor, a threaded assembly, a rail. Rotation of the X axis actuator control moves the carriage laterally, while rotation of the Y axis actuator moves the carriage up or down. The carriage rails are attached to the additional frame, as are the actuator position means assemblies.

The quoin lock and unlock means are two sets of elements, one for the X rows, one for the Y columns. The quoin lock comprises a cam shaft means attached to a cam carriage that slides along a rail, one step motor rotating the cam shaft. The cam shaft is designed to selectively press the rows before and after the ones corresponding to the member position actuator, the one parallel to the X axis on two pairs of quoin assemblies, in three pairs the one in the Y axis. The quoin lock means is attached to the additional frame.

Two modes of operation for the quoin lock: first mode, during the positioning stage, as the carriage holding the member positioning means assemblies is displaced, a corresponding carriage holding the lock cam shaft is set to its position; there, when the cam shaft is actuated, it will press both the previous and the next member row to the one where the member will be positioned, locking them. After a pause suitable for positioning the members, it rotates back, unlocking said rows. This process repeats as many times as the member positioning means are operating, 117 times in this embodiment. The second mode is after the positioning stage and until the pour stage is completed. The plural cam shaft lever is manually rotated, all quoin assemblies of one side are pressed and thus all members locked. The pour completed, the plural cam shaft lever is rotated back, the members are released.

The software for the digital control means will not be detailed, being understood by a person of ordinary skill in the art of three dimensional design for CNC, in this embodiment coded in C and compiled by means of msp430-gcc. Data consists of a multidimensional array uploaded to the MCU. For this particular embodiment, the hardware comprises one Texas Instruments MSP430 MCU, four 4051, a step motor controller for each motor, based on L293D for bipolar steppers and U2004 for unipolar, discrete components, PCB, power source, switches. Reed switches are used to confirm positive reset to the home position.

Other elements comprise those necessary to measure and prepare plaster, and to finish the produced object.

The method for using the embodiment comprises a data preparation stage, an apparatus preparation stage, a positioning stage, a pour stage, and a completion stage.

The data preparation stage comprises designing the object and transferring a multidimensional numeric array to the MCU. This being understood by a person of ordinary skill in the art of three dimensional design for CNC, it will not be detailed here, besides mentioning that each member in the embodiment is assigned a numeric value between 0 and 255, that correspond respectively to no displacement at all and full displacement, respectively 0 in and 2 in in this embodiment.

The apparatus preparation stage comprise checking that the members are sitting properly within the frame, each proximal end abutting the frame aperturate plate; attaching by simple pressure the additional frame, which comprises the control mechanisms; attaching the power source. The embodiment is set in a position where the general plane of the frame is vertical, thus the members are generally horizontal. The shape of the frame and additional frame assure the necessary stability.

Follows the positioning stage. As the first subroutine is called, the control mechanisms find the home position for the carriage, by means of reed switches sensing a magnet permanently attached to the frame. Calling the second subroutine, the relevant elements and assemblies repeatedly follow a sequence, 1) the carriage move to position; 2) lock the quoins corresponding to the immediate rows and columns adjacent to the member that will be positioned;

3) propel the pin according to a position according to the value assigned in the data array; 4) retreat the positioning rod 5) unlock the quoins. The principle in effect is that members belonging to rows or columns that are thus locked will have a higher degree of friction with each other than with the one member that is being positioned, and will not be carried along with it. In the absence of such lock, are a member being positioned, it is likely that lateral friction would also propel any of the other members close to the one being propelled. Be it noted that by using multiple position assemblies, the speed of the stage is reduced as 6 members are positioned penecontemporaneously; Once the second routine has completed it iterations and all members are set, the third routine brings the carriage to a generally central position, and stops.

The user then engages the plural cam shaft, locking the quoins for all the members, and carefully detaches the additional frame comprising the positioning mechanisms.

Carefully a layer of demolding means is applied. Thicker demolding agent will not only make it easier to remove the finished object, it will also fill the jags in the achieved contour. With practice with the demolding agent, chieving products with a smooth surface are possible that need little finishing such as sanding. Then the additional box is set, and the embodiment rotated 90 degrees so the members are now generally vertical, the box forming a sort of bucket.

As a suitable amount of plaster is prepared, about two cups, more if a deeper object is desired. The plaster is poured carefully avoiding trapping air bubbles. A sufficient time is given for the plaster to set.

The completion stage begins with releasing the plural cam shaft. Then carefully the additional box, containing the plaster object, is removed. It is likely that a number of members will have been captured by the plaster, and need be removed carefully. The object is set aside for drying, and any finishing processes. The members, additional box, frame, are carefully cleaned and washed as necessary. Once dry they can be used again.

I claim:

1. A shaping or forming apparatus, comprising:
a plurality of members;
means to selectively lock the members in a set position with a force greater than that used to position unlocked members; and
means to selectively position members relative to each other in more than three different positions;

2. The apparatus of claim 1 where the member holding means comprise a plurality of jointed articulated elements attached together.

3. The apparatus of claim 1 wherein the member movement is at least one mode selected from the group consisting of tilt, rotation, bending, translation.

4. The apparatus of claim 1 where a part of each member is attached by means of a wire or an element or assembly, to at least one other member or to the frame

5. The apparatus of claim 1 where permanent aggregation means lock the members after being set.

6. The apparatus of claim 1 where the dimension in the same major axis of all members is one among at least 3 different length measures, and no set of members of a same dimension is more than 80% of the total of members.

7. The apparatus of claim 1 where rows are not straight

8. The apparatus of claim 1 where at least two flat apertured plates generally parallel to each other hold members, and where the distance between corresponding apertures in at least two said plates is different, therewith at least part of each member is not parallel in relation to the corresponding part of any other member.

9. the member holding means comprise a mesh grate and members are generally perpendicular to said mesh grate

10. The apparatus of claim 1 where members parallel in one row are not parallel to those in another row, both said rows being generally parallel to each other

11. The apparatus of claim 1 where the end of each member is attached to a membrane means

12. The apparatus of claim 1 where members and other elements reconfigure an aerodynamic or hydrodynamic surface, or a surface used for controlling the flow of a fluid or particulates.

13. The apparatus of claim 1 where each member is urged in a direction parallel to its major axis by a spring permanently attached to said member.

14. The apparatus of claim 1 where the member holding means comprise a surface that generally represents at least one of: a human head, an object of nature, an object of manufacture.

15. The apparatus of claim 14 where one end of each member is connected to said surface, therewith the movement of each member being limited to at least one among: tilt, rotation, bending;

16. The apparatus of claim 1 wherein subsets of said members are parallel to each other in rows;
furthermore within said rows and in at least one position, each member not in an extreme of the row is in lateral contact superior to 50% of the length of the member with two other members; and
means to selectively lock the rows in a set position with a force greater than that used to position unlocked members.

17. The apparatus of claim 16 wherein lock means are quoins.

18. The apparatus of claim 16 where members generally parallel to each other are trimmed or segmented to a determined size previous to or after being positioned.

19. A method for making a material object, comprising the steps of:
providing a plurality of members numbering at least one hundred, wherein subsets of said members are parallel to each other in rows, furthermore within said rows and in at least one position, each member not in an extreme of the row is in lateral contact superior to 50% of the member length with two other members;
moving members into a position;
selectively locking the members in a set position with a force greater than that used to position unlocked members

20. A shaping or forming apparatus, comprising:
a plurality of members numbering at least 30;
said members being means for generating a controlled electromagnetic-spectrum force and/or generating a plasma stream and/or controlling a jet of fluid; and
a number of said members not less than 10% being movable in relation to the others.
